(19) United States
(12) Patent Application Publication
(10) Pub. No.: US 2012/0234154 A1
(43) Pub. Date: Sep. 20, 2012

(54) Intonators

(76) Inventor: Richard Heber Tingen, Bradenton, FL (US)

(21) Appl. No.: 12/928,788

(22) Filed: Mar. 15, 2011

(51) Int. Cl. G10D 3/14

(52) U.S. Cl. 84/312 R

(57) ABSTRACT

A system and method for guitar string lengthening and shortening by hand, wherein the screws originally attached to the tailpiece string retainer bridge and connected to a movable string saddle with a guitar string are each replaced by a substitute screw with an enlarged head or knob having a knurled surface and a smooth mating surface between the head or knob and the existing bridge that allows easy, accurate, and convenient hand adjustments to the intonation on the bridge of an electric guitar. It is preferred for the replacement screws having heads or knobs with a knurled surface to be made from stainless steel to avoid corrosion. Optionally, the replacement screws may have a tool slot and a chamfered top edge. Also, for a guitar with six strings, three of the replacement screws would typically have a threaded stem approximately three-fourths of an inch in length, with the other three of the replacement screws typically having a threaded stem of approximately five-eights of an inch in length.

### BACKGROUND OF THE INVENTION

This invention relates to the field of guitar string tuning devices, specifically a system and method of replacing the screws originally attached to the tailpiece string retainer bridge and connected to a movable string saddle attached to a guitar string are each replaced by a substitute screw with an enlarged head or knob having a knurled surface and a smooth mating surface between the head or knob and the existing bridge that allows easy, accurate, and convenient hand adjustments to the intonation on the bridge of an electric guitar. It is preferred for the substitute/replacement screws to be made from stainless steel to avoid corrosion. Optionally, the substitute/replacement screws may have a tool slot and a chamfered top edge. Also, for a guitar with six strings, three of the replacement screws would typically have a threaded stem approximately three-fourths of an inch in length (the first, second, and third strings), with the other three of the replacement screws typically having a threaded stem of approximately five-eights of an inch in length (the fourth, fifth, and sixth strings).

### BRIEF SUMMARY OF THE INVENTION

Through the use of a “modified” screw/screwhead, (i.e. enlarged “knurled,” textured screw head, used for turning the screw with the hand or a tool) adjustments can be made at the bridge of the guitar for intonation adjustments. Thus, the primary objective of this invention is to provide a means for easy, accurate, and convenient hand adjustments to the intonation on the bridge of an electric guitar.

### BRIEF DESCRIPTIONS OF THE SEVERAL VIEWS OF THE DRAWINGS

FIG. 1 is a top view of a prior art tailpiece string retainer bridge and an associated movable string saddle with a guitar string that are joined by a prior art type of screw typical of that provided by guitar manufacturers.

FIG. 2 is a side view of a replacement screw in the most preferred embodiment of the present invention.

FIG. 3 is a perspective view of the replacement screw shown in FIG. 2 with optional tool slot and chamfered top edge.

FIG. 4 is a top view of the replacement screw shown in FIGS. 2 and 3 in a position of use connected to the tailpiece string retainer bridge of a guitar and an associated movable string saddle with a guitar string.

### DETAILED DESCRIPTION OF THE INVENTION

Six #6 size screws from the guitar manufacturer, are replaced by three replacement screws having a threaded stem approximately three-fourths of an inch in length (the first, second, and third strings), with the other three replacement screws having a threaded stem of approximately five-eights of an inch in length (the fourth, fifth, and sixth strings), with the six #6 size replacement screws having enlarged heads, approximately five-sixteenths of an inch in diameter, each also having a textured surface to facilitate hand turning, and an optional tool slot built/milled into the end of the head. A chamfered top edge is also preferred, as seen in FIGS. 2 and 3. Manufacture of these replacement screws is a “metal-lathe” operation. The use of these replacement screws with oversized textured/“knurled” heads is to adjust the intonation on the bridge of a guitar by hand, providing greater ease, accuracy, and convenience, which allows pitch adjustment and fine-tuning of the guitar while actually playing the instrument.

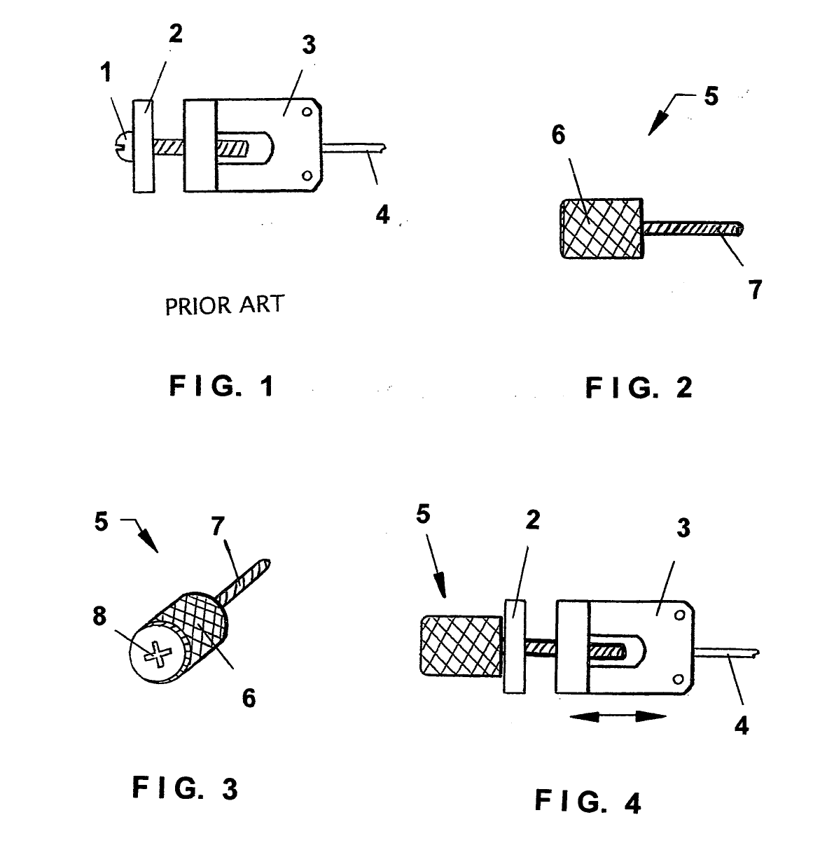

FIG. 1 is a top view of a prior art tailpiece string retainer bridge 2 and an associated movable string saddle 3 with a guitar string 4 that are joined by a prior art screw 1 typical of that provided by guitar manufacturers. As prior art screw 1 is turned, saddle 3 moves allowing a length change in string 4. The movement in saddle 3 is shown by the double-headed arrow in FIG. 4.

FIGS. 2-4 show the replacement screw 5 of the present invention, with the position of use shown in FIG. 4. FIG. 2 is a side view of replacement screw 5, showing a threaded stem and head 6 having a knurled surface. FIG. 2 also shows the chamfered top edge (which is not separately numbered). FIG. 3 is a perspective view of replacement screw 5 showing an optional tool slot 8 on head 6, threaded stem 7, and the chamfered top edge (unnumbered) also on head 6. FIG. 4 is a top view of replacement screw 5 shown in a position of use connected to the tailpiece string retainer bridge 2 of a guitar and an associated movable string saddle 3 with a guitar string 4.

I claim:

1. A system for making hand adjustments at the bridge of a guitar, to the intonation of the guitar, by means of lengthening and shortening string span, said system comprising:
a screw with an oversized, enlarged head having a knurled exterior surface, a threaded stem having a length sufficient to extend through a tailpiece string retainer bridge on a guitar and also thread into an associated movable string saddle, said head also having a smooth mating surface where said head is in contact with the bridge, wherein said knurled head allows easy, accurate, and convenient hand adjustment to the intonation on the bridge of a guitar, providing pitch adjustment tuning of the guitar while it is being played.

2. The system of claim 1 wherein said head has a top end, and said top end has a tool slot.

3. The system of claim 1 wherein said head has a length dimension of approximately five-sixteenths of an inch.

4. The system of claim 1 wherein said head has a diameter dimension of approximately five-sixteenths of an inch.

5. The system of claim 1 wherein said head has a length dimension of approximately five-sixteenths of an inch and a diameter dimension of approximately five-sixteenths of an inch.

6. The system of claim 1 further comprising three of said screws having a threaded stem with a length dimension of approximately three-fourths of an inch and three of said screws having a threaded stem with a length dimension of approximately five-sixteenths for pitch adjustment tuning of a guitar.

7. A method for fine tuning a guitar having a tailpiece string retainer bridge and an associated movable string saddle, said method comprising the steps of:
providing the screw of claim 1;
extending said threaded stem of said screw through a tailpiece string retainer bridge on a guitar and also threading said stem into an associated movable string saddle so that said smooth mating surface of said head is drawn into contact with the bridge by the tensioned guitar string on the saddle; and
turning said knurled head to move the saddle to change string length, providing easy, accurate, and convenient hand adjustment to the intonation on the bridge of a guitar while it is being played.

8. The method of claim 7 wherein said head has a top end, and said top end has a tool slot.

9. The method of claim 7 wherein said head has a length dimension of approximately five-sixteenths of an inch.

10. The method of claim 7 wherein said head has a diameter dimension of approximately five-sixteenths of an inch.

11. The method of claim 7 wherein said head has a length dimension of approximately five-sixteenths of an inch and a diameter dimension of approximately five-sixteenths of an inch.

12. The method of claim 7 further providing three of said screws having a threaded stem with a length dimension of approximately three-fourths of an inch, and three of said screws having a threaded stem with a length dimension of approximately five-sixteenths.
